(19) United States
(12) Patent Application Publication
(10) Pub. No.: US 2026/0340760 A1
(43) Pub. Date: Oct. 29, 2026

(54) IMAGE DATA WRITING AND READING METHOD AND APPARATUS, COMPUTER DEVICE, COMPUTER-READABLE STORAGE MEDIUM AND COMPUTER PROGRAM PRODUCT

(71) Applicant: Glenfly Tech Co., Ltd., Shanghai (CN)

(72) Inventors: Yuzhuo LIU, Shanghai (CN); Lichuan ZHANG, Shanghai (CN)

(21) Appl. No.: 19/660,550

(22) Filed: Apr. 28, 2026

(30) Foreign Application Priority Data
Apr. 28, 2025 (CN) 202510554379.9

(51) Int. Cl. G06T 1/60; G06F 3/06; G06T 1/00

(52) U.S. Cl. CPC G06T 1/60; G06F 3/0604; G06F 3/0656; G06F 3/0679; G06T 1/0007

(57) ABSTRACT

An image data writing method, an image data writing apparatus, a computer device, a computer-readable storage medium, and a computer program product are provided. The method includes: acquiring to-be-processed image data; rearranging the to-be-processed image data based on a storage width of a pre-buffer to obtain arrangement information; storing the to-be-processed image data into the pre-buffer based on the arrangement information; and writing the to-be-processed image data from the pre-buffer into a line buffer array when a number of lines of the pre-buffer have been filled with data. The method can improve the storage efficiency.

### CROSS-REFERENCE TO RELATED APPLICATION

The present disclosure claims priority to Chinese Patent Application No. 202510554379.9, filed with CNIPA on Apr. 28, 2025, entitled “IMAGE DATA WRITING AND READING METHOD AND APPARATUS, COMPUTER DEVICE, COMPUTER-READABLE STORAGE MEDIUM AND COMPUTER PROGRAM PRODUCT”, the entire content of which is incorporated herein by reference.

### TECHNICAL FIELD

The present disclosure relates to the technical field of image technologies, and in particular, to an image data writing method, an image data reading method, an image data writing apparatus and an image data reading apparatus, a computer device, a computer-readable storage medium, and a computer program product.

### BACKGROUND

With the rapid development of video image processing technology, the storage and processing requirements of image data are increasing. Especially, in high-resolution and multi-channel image processing scenarios, temporary storage and access operations need to be performed on data frequently. Therefore, how to efficiently store image data to adapt to different format requirements has become a focus of industry attention.

In a conventional image storage method, pixel data in an image is stored line by l or column by column into respective lines of a memory, using a pixel-by-pixel storage manner. Although this method is simple and intuitive, the data storage efficiency is very low.

### SUMMARY

In view of the above technical problem, it is necessary to provide methods and apparatuses for writing and reading image data, a computer device, a computer-readable storage medium and a computer program product, which can improve storage efficiency.

According to a first aspect, the present disclosure provides an image data writing method, including:
obtaining to-be-processed image data;
rearranging the to-be-processed image data based on a storage width of a pre-buffer to obtain arrangement information;
storing the to-be-processed image data into the pre-buffer based on the arrangement information; and
writing the to-be-processed image data from the pre-buffer into a line buffer array (LBA) when a preset number of lines of the pre-buffer are filled with data.

In an embodiment, after obtaining the to-be-processed image data, the method further includes: performing channel merging in a case that the to-be-processed image data includes multiple channels.

In an embodiment, performing channel merging includes:
performing channel separation on each pixel in the to-be-processed image data to obtain channel streams corresponding to each pixel on respective channels; and
merging channel streams corresponding to respective pixels on a same channel.

In an embodiment, rearranging the to-be-processed image data based on the storage width of the pre-buffer to obtain the arrangement information includes:
calculating a number of occupied lines of the to-be-processed image data in the pre-buffer based on a channel bit width of the to-be-processed image data and the storage width; and
reordering the to-be-processed image data based on the number of occupied lines to obtain the arrangement information.

In an embodiment, writing the to-be-processed image data from the pre-buffer into the LBA includes:
partitioning the LBA based on the to-be-processed image data to obtain multiple sections; and
writing the to-be-processed image data from the pre-buffer into respective sections.

In an embodiment, after partitioning the LBA based on the to-be-processed image data to obtain the multiple sections, the method further includes:
calculating a number of lines per section based on a width of the to-be-processed image data, a pixel bit width, a number of memory sections in the LBA, and a width of the memory section; and
partitioning the respective sections of the LBA according to the number of lines per section to obtain multiple blocks.

In an embodiment, each section has multiple lines, and the to-be-processed image data is stored in the pre-buffer as data blocks; and writing the to-be-processed image data into respective sections includes:
determining a target section based on a line number of each data block and the number of lines per section;
determining a target line in the target section based on a column number of the each data block and the width of the memory section; and
writing the each data block into the target line.

In an embodiment, the LBA further includes an arbitration unit, and the arbitration unit arbitrates multiple received data write requests according to a preset arbitration manner, determines a target data write request, and writes the to-be-processed image data corresponding to the target data write request into the LBA.

In an embodiment, the preset arbitration manner includes one or any combination o a round-robin arbitration, a priority arbitration, and a non-least recently used arbitration;
the round-robin arbitration is to sequentially arbitrate the data write requests according to a preset order;
the priority arbitration is to arbitrate the data write requests according to preset priorities; and
the non-least recently used arbitration is to arbitrate the data write requests according to a waiting time of each of the data write requests.

According to a second aspect, the present disclosure provides an image data reading method, including:
sending a read request to a line buffer array (LBA), the read request carrying a read location;
reading target data from the LBA based on a sequence number of a section and a sequence number of a block comprised in the reading location, wherein to-be-processed image data is rearranged based on a storage width of a pre-buffer and then stored in the LBA; and
reversely arranging the target data based on the storage width.

According to a third aspect, the present disclosure further provides an image data writing apparatus, including:
an obtaining module, configured to obtain to-be-processed image data;
a rearranging module, configured to rearrange the to-be-processed image data based on a storage width of a pre-buffer to obtain arrangement information;
a storage module, configured to store the to-be-processed image data into the pre-buffer based on the arrangement information; and
a writing module, configured to write the to-be-processed image data from the pre-buffer into a line buffer array when a preset number of lines of the pre-buffer are filled with data.

According to a fourth aspect, the present disclosure further provides an image data reading apparatus, including:
a request sending module, configured to send a read request to a line buffer array (LBA), the read request carrying a read location;
a reading module, configured to read target data from the LBA based on a sequence number of a section and a sequence number of a block comprised in the reading location, wherein to-be-processed image data is rearranged based on a storage width of a pre-buffer and then stored in the LBA; and
a reverse arrangement module, configured to perform reverse arrangement on the target data according to the storage width.

According to a fifth aspect, the present disclosure further provides a computer device, including a memory and a processor. The memory stores a computer program, and the processor, when executing the computer program, performs steps of the method in any one of the foregoing embodiments.

According to a sixth aspect, the present disclosure further provides a non-transitory computer-readable storage medium, storing a computer program. The computer program, when executed by a processor, causes the processor to perform steps of the method in any one of the foregoing embodiments.

According to a seventh aspect, the present disclosure further provides a computer program product, including a computer program. The computer program, when executed by a processor, causes the processor to perform steps of the method in any one of the foregoing embodiments.

In the above-mentioned methods and apparatuses for writing and reading image data, the computer device, the computer-readable storage medium, and the computer program product, the to-be-processed image data is obtained and then rearranged based on the width of the pre-buffer. Since the data is aligned and grouped based on the storage width of the pre-buffer in the rearrangement process, and it is ensured that each storage unit is filled as much as possible, blank or redundant areas in the storage unit are reduced, enabling dense storage of the data in the pre-buffer. With the dense arrangement manner, the data, when being written into the LBA, can directly adapt to the storage structure of the LBA without any additional alignment operations or format conversion, thereby significantly improving the storage efficiency of the LBA.

### BRIEF DESCRIPTION OF THE DRAWINGS

In order to clearly illustrate technical solutions of embodiments of the disclosure, drawings of the embodiments of the disclosure are briefly described in the following. It is obvious that the described drawings are only related to some embodiments of the disclosure. Other drawings can be obtained based on these described drawings by the ordinary skilled in the art without paying creative efforts.

FIG. 1 shows an LBA storage manner according to an embodiment;

FIG. 2 is a diagram of an application environment of an image data writing method according to an embodiment;

FIG. 3 is a schematic flowchart of an image data writing method according to an embodiment;

FIG. 4 illustrates a structure of a pre-buffer according to an embodiment;

FIG. 5 is a schematic diagram of channel merging according to an embodiment;

FIG. 6 is a schematic diagram of an LBA storage manner according to an embodiment;

FIG. 7 is a schematic structural diagram of an ILBA according to an embodiment;

FIG. 8 is a block diagram of an LBA in an embodiment;

FIG. 9 is a schematic diagram of steps of an image data writing method according to an embodiment;

FIG. 10 is a schematic flowchart of an image data reading method according to an embodiment;

FIG. 11 is a schematic diagram of steps of an image data reading method according to an embodiment;

FIG. 12 is a structural block diagram of an image data writing apparatus according to an embodiment;

FIG. 13 is a structural block diagram of an image data reading apparatus according to an embodiment; and

FIG. 14 is an internal structural diagram of a computer device according to an embodiment.

### DETAILED DESCRIPTION

To further clarify objectives, technical solutions, and advantages of the present disclosure, the following further details the present disclosure according to embodiments in conjunction with accompanying drawings. It is understood that specific embodiments described herein are used to explain, rather than limit, the present disclosure.

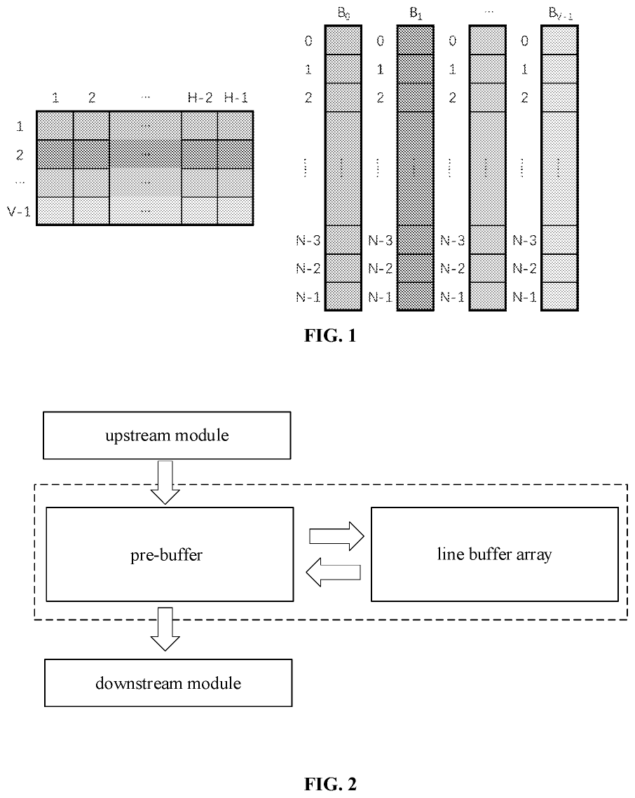

In the hardware design of a line buffer array (LBA), multiple static random access memories (SRAMs) are usually used in parallel. Each line buffer can store the content of one data line, and the LBA is usually applied in application scenarios processing multiple lines of data. The storage manner of the array is shown in FIG. 1, where the part on the left sides schematic diagram of image data, which is composed of V*H pixels, and the part on the right is an LBA composed of V buffers, each buffer having a depth N. The storage manner for the data is to store each line of data in the image into one buffer in the LBA.

Obviously, the storage manner of the conventional LBA is disadvantageous in that, the depth N of the LBA must be greater than or equal to an image width H, so that respective lines of data can be completely accommodated into respective buffers of the LBA for storage. In addition, the conventional LBA can only process a fixed number of lines of data, that is, since the LBA is designed into V buffers, only V lines of data can be processed simultaneously. More than V lines of data cannot be processed, while the storage space of the LBA is wasted for processing less than V lines of data.

In the LBA, each buffer is responsible for storing one line of data, so the depth N of each buffer must be greater than or equal to the image width H. If the image width H is too large, problems may be caused. For example, assuming that the resolution of the image is 1920×1080, and the corresponding storage requirement is that each line requires 1920 units or storage; hence, the buffer depth N is equal to or greater than 1920. As the image width increases, for instance, H of a 4K image equals 3840, the depth N of each buffer needs to be further increased accordingly, resulting in occupancy of more resources on chip.

Besides, the number V of buffers in the LBA determines the number of lines that can be processed simultaneously. For example, assuming that an application needs to process an image of a 5-line sliding window and only 3 buffers (i.e., V=3) are allocated for the designed LBA; in this case, the operation of the sliding window requires 5 lines of data, but the LBA cannot complete the operation because it cannot store 5 lines of data at the same time. Consequently, hardware must be redesigned and the number of buffers is increased, resulting in poor design flexibility. In a case that the LBA is designed with 8 buffers (i.e., V=8), but only 3 lines of data are required practically, 5 buffers remain unused, causing the waste of storage resources.

The present disclosure provides an image data writing method, which introduces a preprocessing buffer (pre-buffer for short) to rearrange to-be-processed image data, to improve the storage space of the LBA.

FIG. 2 is a diagram of an application environment of an image data writing method according to an embodiment. The image data writing method proposed in the present disclosure is applied to an improved line buffer array (ILBA) which includes a pre-buffer and an LBA. The pre-buffer acquires to-be-processed image data from an upstream module, and then rearranges the to-be-processed image data to obtain arrangement information. The to-be-processed image data is stored into the pre-buffer based on the arrangement information. When data has been written into a preset number of lines of the pre-buffer, the to-be-processed image data is written into the LBA from the pre-buffer.

Correspondingly, if data is read from the LBA, the ILBA receives a data read request from a downstream module. Then, target data is read from the LBA, and is reversely arranged, that is, subjected to a reverse process of the rearrangement performed by the pre-buffer on the to-be-processed image data.

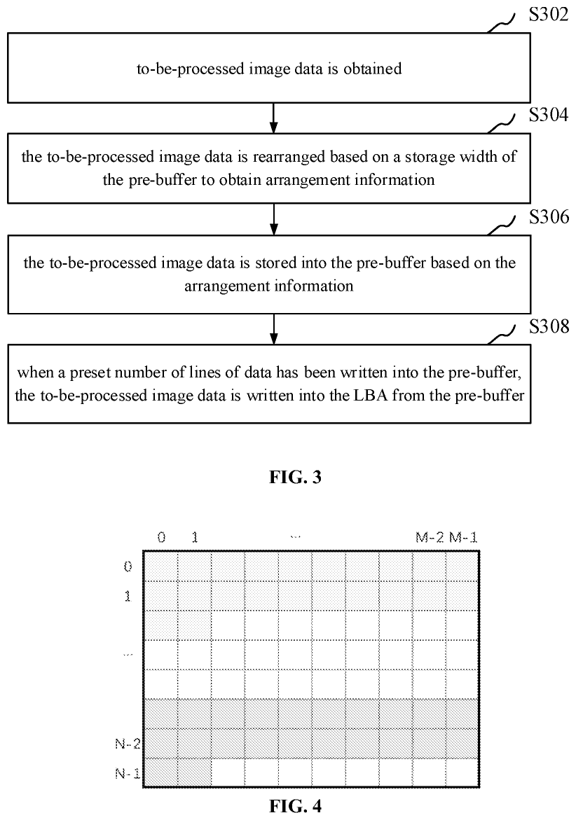

In an exemplary embodiment, an image data writing method is provided. It is exemplarily described that the method is applied to the pre-buffer shown in FIG. 2. As shown in FIG. 3, the method includes the following step 302 to step 308.

In step 302, to-be-processed image data is obtained.

The to-be-processed image data is transmitted from the upstream module. It may be multi-channel data such as in a YUV420 format, or single-channel data such as a grayscale image.

For example, the to-be-processed image data may be data with a resolution of 1920×1080 and a format of YUV420, and a pixel sequence of the to-be-processed image data is [Y1, U1, V1, Y2, U2, V2, . . . ].

In step 304, the to-be-processed image data is rearranged based on a storage width of the pre-buffer to obtain arrangement information.

In the embodiment, the received to-be-processed image data is reordered based on a storage structure and a width requirement of the pre-buffer, to adapt to a storage requirement of the pre-buffer, and the arrangement information is obtained. The arrangement information refers to information such as a specific storage order and locations of the data in the pre-buffer.

Further, rearranging the to-be-processed image data based on the storage width of the pre-buffer refers to: grouping and alignedly storing the to-be-processed image data based on the storage width of the pre-buffer. In this way, the stored data is consistent with the structure of the pre-buffer, optimizing the utilization rate of the storage space and improving the efficiency of subsequent processing.

For example, the storage width of the pre-buffer is 32 bits, which is capable of storing the data of four pixels, each pixel occupying 8 bits; and to-be-processed image data is [P1, P2, P3, P4, P5, . . . , P1920]. Pₙ represents a grayscale value of an n-th pixel, ranging from 0 to 255, so the grayscale value is indicated by 8 bits. Therefore, the to-be-processed image data may be grouped in a way that every four pixels form one group, which is specifically as follows:
Group 1:[P₁,P₂,P₃,P₄]
Group 2:[P₅,P₆,P₇,P₈]
. . .
Group 480:[P₁₉₁₇,P₁₉₁₈,P₁₉₁₉,P₁₉₂₀]

As such, respective groups of image data are stored into the pre-buffer.

In other embodiments, if the pixels in a certain group are insufficient to fill a storage unit of the pre-buffer, padding may be performed. For example, a to-be-processed image is a single-channel image with a width of 1918 and the 480-th group of data is [P₁₉₁₇,P₁₉₁₈], invalid data such as 0 is padded, and then the 480-th group of data turns into [P₁₉₁₇,P₁₉₁₈, 0,0].

Exemplarily, reference can be made to FIG. 4, which illustrates a structure of a pre-buffer according to an embodiment. The pre-buffer has a depth of N and a width of M bits. To facilitate reading from the LBA, the width of the pre-buffer is usually set identical to a width of a memory section, i.e., a bank in the LBA, and the depth of the pre-buffer needs to be set based on different design requirements.

Based on common data formats such as 32 bpp RGBA, 20 bpp P010, or 12 bpp NV12, the pre-buffer structure may be designed to have a width of 80 bits. That is, fast image data reading and writing is met, and various format requirements are supported. In addition, partial space may be flexibly used. For example, when there is an Alpha channel in a data format, a part of space is used to store the Alpha channel; if there is no Alpha channel, the part of space may store data of a channel other than Alpha channel.

In step 306, the to-be-processed image data is stored into the pre-buffer based on the arrangement information.

Based on the arrangement information generated in step 304, the to-be-processed image data is stored into the pre-buffer according to a grouping result.

With reference to the foregoing example, data of group 1 is stored in line 0 of the pre-buffer, and each time one line is stored, a line count of the pre-buffer is updated.

In step 308, when a preset number of lines of the pre-buffer have been filled with data, the to-be-processed image data is written into the LBA from the pre-buffer.

The preset number of lines, which is associated with a trigger condition for writing the to-be-processed data from the pre-buffer into the LBA, is set in advance, and it can be set according to an actual application scenario.

For example, the preset number of lines is set to 4. When 4 lines of the pre-buffer have been filled with data, the to-be-processed data is written into the LBA from the pre-buffer.

Since the storage width of the pre-buffer is identical to a memory width of the LBA, for example, both are 32 bits, no additional data format conversion or alignment operation is required in a data transmission process from the pre-buffer to the LBA, implementing efficient direct writing.

In the above image data writing method, after the to-be-processed image data is obtained, the to-be-processed image data is rearranged based on the width of the pre-buffer. Since the data is aligned and grouped based on the storage width of the pre-buffer in th rearrangement process, and it is ensured that each storage unit is filled as much as possible, blank or redundant areas in the storage unit are reduced, enabling the dense storage of the data in the pre-buffer. With the dense arrangement manner, the data, when being written into the LBA, can directly adapt to the storage structure of the LBA without any additional alignment operations or format conversion, thereby significantly improving the storage efficiency of the LBA.

Further, after obtaining the to-be-processed image data, the method further includes performing channel merging in a case that the to-be-processed image data includes multiple channels.

Among the data of a multi-channel image in, e.g., YUV420 format, the luma channel (Y) and chroma channels (U, V) have different resolutions or amounts of data. If the data of each channel is stored independently, the amount of data of a single channel may not completely fill the width of the storage unit, resulting in a waste of storage space.

Thus, in the embodiment, at least two channels are merged for storage in the LBA. Through channel merging, the data of various channels can be packed and stored in the same storage unit, thereby reducing unused empty packet areas.

Further, performing channel merging includes: performing channel separation on each pixel in the to-be-processed image data to obtain channel streams corresponding to each pixel on respective channels; and merging channel streams corresponding to respective pixels on a same channel.

The image data generally includes multiple channels, for example, the YUV420 format includes a luma channel Y and chroma channels U, V, and the data of each pixel includes information of multiple channels. Through channel separation, the data of respective channels of each pixel is separated to form multiple independent channel streams.

For example, for original pixel data [Y1, U1, V1], [Y2, U2, V2], [Y3, U3, V3], . . . , it is separated into: Y=[Y1, Y2, Y3, . . . ], U=[U1, U2, U3, . . . ], V=[V1, V2, V3, . . . ].

Then, data streams of all pixels on a same channel are merged to form a continuous data block, which is convenient for subsequent storage or transmission. Data blocks obtained after merging are as follows:
Y channel: [Y1, Y2, Y3, . . . , Yn]
U channel: [U1, U2, U3, . . . , Un]
V channel: [V1, V2, V3, . . . , Vn]

Through the channel separation and the subsequent merging, the space in the storage unit is prevented from redundancy and waste, thereby improving the utilization rate of the storage space.

For example, assuming that the width of the storage unit is 32 bits, channel U and channel V, if separately stored, each occupy 8 bits, and then space of remaining 16 bits of the storage unit is wasted. Through channel merging, 8-bit data of channel U and 8-bit data of channel V may be merged into a same storage unit, and a 32-bit storage unit is filled by the merged data of channels U and V together with data of channel Y, thereby reducing storage space waste.

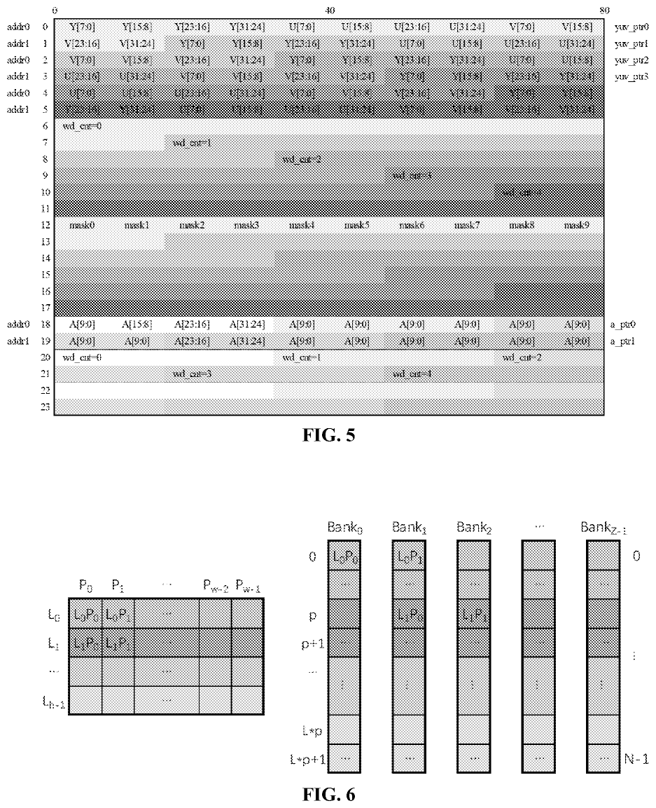

Reference may be made to FIG. 5, which is a schematic diagram of channel merging in an embodiment. In the embodiment, taking the storage of 32 bpp YUVA data as an example, the YUVA data format is composed of 4 channels: a luma channel Y, chroma channels U and V, and a transparency channel Alpha. Each channel occupies 8 bits, so one YUVA pixel value occupies 32 bits. When a module needs to process the data volume of 4 Pixel/T, the workflow of the pre-buffer is as follows.

First, each of 4 pixels is split into 4 channels according to YUVA, so there are 16 channels in total, and each channel has 8 bits. Secondly, data of different pixels on the same channel are combined together to be stored consecutively in the LBA, i.e., 32 bits of data on channel Y, 32 bits of data on channel U, 32 bits of data on channel V, and 32 bits of data on channel Alpha. Then, the data of channel Y, the data of channel U, and lower 16 bits of the data of channel V are written into a first line of the pre-buffer; higher 16 bits of the data of channel V, and the data of channels Y and U at a next moment are written into a second line of the pre-buffer; and the data of channel V at the next moment and the data of channels Y, U and V at following moments are sequentially written into the lines of the pre-buffer. When 4 lines of data has been written into the pre-buffer, the data in the pre-buffer is written into 4 memory sections in the LBA.

Since the YUVA is 32 bpp and the memory section in the LBA is 80 bits, only 2 pixels can be stored in the memory section according to a traditional pixel placement mode, and consequently, the space utilization rate is only 80%. According to the storage manner designed in the present disclosure, the YUVA is split into four 8-bit channels, so one memory section can store 10 channels and a local space utilization rate of the LBA can reach 100% theoretically, thereby effectively improving the overall storage efficiency.

In an exemplary embodiment, rearranging the to-be-processed image data based on the storage width of the pre-buffer to obtain the arrangement information includes: calculating a number of occupied lines of the to-be-processed image data in the pre-buffer based on a channel bit width of the to-be-processed image data and the storage width; and reordering the to-be-processed image data based on the number of occupied lines to obtain the arrangement information.

The arrangement information records storage locations of the data of each channel, for example, line numbers and column numbers of the storage locations, and records a storage start address and a storage end address.

Rearranging refers to reorganizing the to-be-processed image data based on the storage width of the pre-buffer, so that the data can efficiently adapt to the structure of the pre-buffer, thereby reducing the waste of storage space and preparing for subsequent writing into the LBA.

First, based on the channel bit width of the to-be-processed image data and the storage width of the pre-buffer, a number of lines that the image data needs to occupy in the pre-buffer is calculated; and the data is reordered according to a storage rule associated with a result of the calculation.

In some implementations, the to-be-processed image data is grouped into multiple groups based on the channel bit width of the to-be-processed image and the storage width of the pre-buffer. Each group is to be stored in the storage unit of the pre-buffer as one data block. In addition, the number of lines that the image data needs to occupy in the pre-buffer is calculated based on a storage capacity of each line of the pre-buffer, and the data is reordered according to the storage rule associated with the result of the calculation.

For example, it is assumed that the to-be-processed image data is a grayscale image having an image resolution of 1920×1080, a pixel bit width is 8 bits, and the storage width of the pre-buffer is 32 bits. Each line of the image data has 1920 pixels, each pixel occupies 8 bits, so a total width of each line of data is calculated to be: 1920×8=15360 bits. A number of storage units required for storing each line of data is calculated to be: 15360/32=480. The total number of lines of the image is 1080, so the number of occupied units in total is calculated to be: 480×1080. The data is grouped based on the storage width of the pre-buffer, which is 32 bits. Each group stores 4 pixels, and each line of data is grouped into 480 groups, which are stored as follows:
[P1, P2, P3, P4], [P5, P6, P7, P8], . . . , [P1917, P1918, P1919, P1920].

It is assumed that each line of the pre-buffer is composed of 256 storage units. For instance, a first line of data, which includes 480 groups, may occupy 1.875 lines of the pre-buffer, that is, a first line of the pre-buffer stores 256 groups, and a second line of the pre-buffer stores the remaining 224 groups. As for each of other lines of the image data, each line includes 480 groups and may occupy a space equal to the space of 1.875 lines of the pre-buffer. The space of 1.875 lines of the pre-buffer means a sum of the space of one line of the pre-buffer and 87.5% of the space of one line of the pre-buffer.

For example, in an embodiment, it is assumed that the to-be-processed image data is multi-channel data, for example, YUV420. After the image data is separated into different channels according to the steps described in the foregoing embodiment, the data of different channels is sorted according to a channel priority order; and then the data of respective channels is divided into blocks based on the calculated number of occupied lines, each block of data filling one storage unit. The remaining processes are consistent with those for the single-channel image data, and are not repeated herein.

Before discussion on writing the to-be-processed image data into the LBA from the pre-buffer, a storage manner of the LBA in the present disclosure is first introduced. In the present disclosure, the LBA is regarded as a whole, and the LBA is divided into several parts through a calculation based on an image size, a pixel format and an LBA capacity, each part storing one line of image data. Specific reference can be made to FIG. 6, which is a schematic diagram of an LBA storage manner in an embodiment.

Writing the to-be-processed image data into the LBA from the pre-buffer may include: partitioning the LBA based on the to-be-processed image data to obtain multiple sections; and writing the to-be-processed image data from the pre-buffer into respective sections.

First, based on the to-be-processed image data, a size of the LBA part required by each line of image data, that is, the size of each section, is calculated; and then the to-be-processed image data is written into respective sections from the pre-buffer.

The LBA is divided into several consecutive sections, and the size of each section equal to or slightly larger than the space required for each line of image data. Each section is assigned a unique identifier or address to enable quick location when reading or writing image data.

Optionally, the image data may be written into the corresponding LBA sections line by line or multiple lines at once, as required.

Partitioning the LBA may further include: calculating a number of lines per section based on a width of the to-be-processed image data, a pixel bit width, a number of memory sections in the LBA, and a width of the memory section; and partitioning the respective sections of the LBA according to the number of lines per section to obtain multiple blocks.

The number of lines per section refers to a number of storage lines required by each memory section. After obtaining the number of storage lines required by each memory section, the memory sections of the LBA are divided according to the number of lines per section to obtain multiple blocks.

Optionally, the number of lines per section is a number of lines included in one section, which is determined based on the width of the to-be-processed image data, the pixel bit width, the number of memory sections in the LBA, and the width of the memory section.

Exemplarily, a formula for calculating the number of lines per section is shown in formula (1) as follows:

pitch=w/(z*k/x) Formula (1)
where, w represents a number of pixels of one line of image data; x represents a pixel bpp; z represents a number of banks in the LBA, that is, the number of memory sections in the LBA; k represents a bit width of each bank, that is, the width of the memory section; and pitch represents the number of lines per section. As such, the LBA is divided into multiple memory sections/banks, and each memory section/bank has multiple lines.

The to-be-processed image data is stored in the pre-buffer as data blocks. Correspondingly, writing the to-be-processed image data into respective sections includes: determining a target section based on a line number of each data block and the number of lines per section; determining a target line in the target section based on a column number of the each data block and the width of the memory section; and writing the each data block into the target line.

The pre-buffer includes multiple storage units, each storage unit stores the data of multiple pixels. With reference to the example in the foregoing embodiment, one storage unit stores a group of data, and the group of data is regarded as one data block, so the to-be-processed image data is stored in the pre-buffer as data blocks. When writing the to-be-processed image data stored in the pre-buffer into respective sections, the section, i.e., the target section where each data block is to be located in the LBA needs to be determined, and after the target section is determined, the line, i.e., the target line where the each data block is to be located within the target section is determined.

The respective data blocks are stored in lines in the pre-buffer; hence, the target section can be solved based on the line number of each data block and the number of lines per section.

A sequence number of the target section may be calculated to be equal to: the line number divided by pitch.

For example, pitch is equal to 30, and if the line number of a certain data block is 60, the sequence number of the target section is calculated to be: 60/30=2. That is, the data block shall be located in the second memory section of the LBA.

In the above, the target section is determined based on the line number of the data block. Further, it is necessary to determine a specific location within the target section for storing the data block based on the column number of the data block.

Optionally, the location of the target line is determined based on a mapping between the column number and the width of the memory section.

A sequence number of the target line equals to: the column number divided by width of the memory section.

Till now, for each data block, the target section and the target line in the LBA can be determined. Then, the data block may be written into the corresponding target line within the target section.

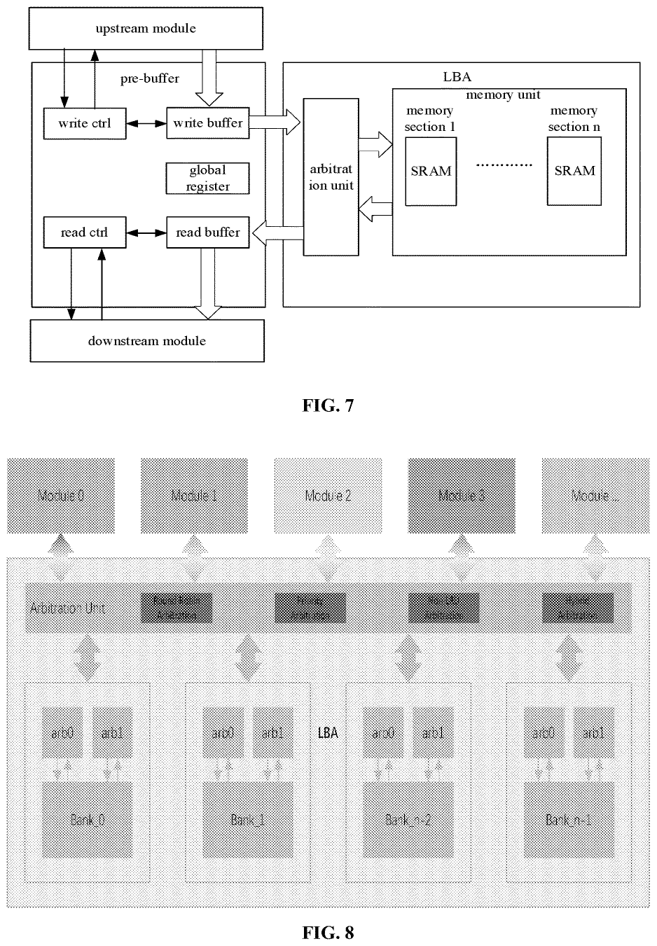

A detailed structure of the ILBA is provided in an exemplary embodiment. Specific reference may be made to FIG. 7, which is a schematic structural diagram of the ILBA according to the embodiment.

The pre-buffer mainly includes a write control unit (write ctrl), a write buffer, a read control unit (read ctrl), a read buffer, and a register configuration unit (global register).

The write control unit is responsible for receiving upstream data, analyzing a pixel format, calculating image write coordinates and an LBA write address, constructing a write buffer dense placement strategy, and controlling data to be written into the write buffer. The write buffer is responsible for separating pixels, buffering data, and writing the data into the LBA. The read control unit is responsible for calculating image read coordinates and an LBA read address, controlling the read buffer to read data from the LBA, and sending the data to a downstream module. The read buffer is a reverse operation of the write buffer and has a same structure as the write buffer. The read buffer is responsible for reading data from the LBA, reorganizing pixels according to the requirement of a needed format, and sending the data to the downstream module. The register configuration unit configures global variables such as an image size, a pixel format, and an arbitration mode.

The LBA mainly includes an arbitration unit and a memory unit.

In a case that multiple modules share one LBA, the arbitration unit is configured to schedule an execution sequence of requests from the multiple modules, thereby optimizing performance of the storage system, reducing a request processing delay, and improving LBA working efficiency. The memory unit includes N banks, and each bank corresponds to two static random access memories (SRAMs).

It can be seen that, in the above embodiment, the pre-buffer can rearrange the to-be-processed image data based on the storage width of the pre-buffer to obtain the arrangement information, and the LBA further includes the arbitration unit.

Reference is made to FIG. 8, which is a block diagram of an LBA according to an embodiment. As shown in FIG. 8, the LBA in the embodiment may be shared by multiple modules, that is, the multiple modules may simultaneously send read/write requests to the LBA. An arbitration unit is designed inside the LBA to schedule the execution sequence of the requests from the multiple modules, thereby reducing the request waiting time and improving the system execution efficiency.

Upon reception of multiple data write requests, the arbitration unit determines a target data write request from the multiple data write requests using a preset arbitration manner, and writes to-be-processed image data corresponding to the target data write request into the LBA.

The preset arbitration manner includes one or any combination of round-robin arbitration, priority arbitration, and non-least recently used (non-LRU) arbitration. Round-robin arbitration is to sequentially arbitrate the data write requests according to a preset order. Priority arbitration is to arbitrate the data write requests according to preset priorities. Non-LRU arbitration is to arbitrate the data write requests according to a waiting time of each of the data write requests.

Round-robin arbitration ensures that all requesters can obtain access permissions in sequence. In this manner, an arbiter authorizes respective requesters in turn in a fixed order, regardless of the priority of each request. Round-robin arbitration can ensure that all requesters have equal opportunities to obtain the access permissions, avoiding the case that a certain requester occupies resources for a long time. In addition, the access order is fixed, and a next authorized requester that obtains the access permission can be predicted.

Priority arbitration determines which requester is to be granted the access permission according to the priorities of respective requests. The priority may be set based on various factors, e.g., the urgency of the request, the type of the requestor, etc. Priority arbitration ensures that a high-priority request can obtain access permission more quickly, so i tis applicable to scenarios requiring fast responses. Moreover, the setting of the priorities may be adjusted according to actual requirements to adapt to different application scenarios. The implementation of priority arbitration is typically more complex than round-robin arbitration, requiring additional logic to handle priority determinations and updates.

For non-LRU arbitration, an LRU request is prioritized, and the LRU request is responded accordingly. Upon completion of a certain request, the request is set with the lowest priority while the priorities of other requests remain unchanged. Non-LRU arbitration can allocate resources to those requests that have not been responded for a long time.

Hybrid arbitration refers to utilize multiple arbitration manners. Due to combination of advantages of multiple arbitration manners, hybrid arbitration can flexibly adapt to different application scenarios. For example, the arbitration unit can employ round-robin arbitration to ensure fairness when the system load is low, and switch to priority arbitration to improve the response speed when the system load is high. The hybrid arbitration manner can dynamically adjust the arbitration manner according to the system state and requirements, which can improve the overall performance of the system while maintaining certain fairness.

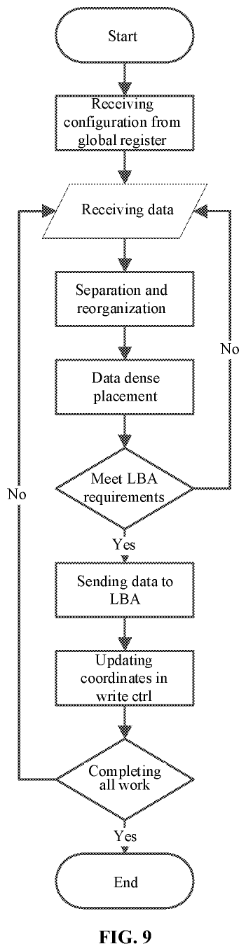

Reference can be made to FIG. 9, which is a schematic diagram of steps of an image data writing method according to an exemplary embodiment.
1) A configuration file is received from the global register. With the configuration file, an image size, an input data format, an input data volume, and LBA space locations and sizes are analyzed, and a dense arrangement scheme is provided.
2) Receiving data: the write ctrl communicates with the upstream, starts to receive data, records image coordinates, and writes the received data into the write buffer as to-be-processed image data.
3) Channel separation: for multi-channel image data, each pixel is separated into different channels. For details, refer to channel separation and channel merging in the foregoing embodiments.
4) Data reorganization: the data is reorganized based on a channel bit width and a storage structure of the LBA, that is, the to-be-processed image data is rearranged. For a specific process, reference can be made to the description about rearrangement in the foregoing embodiments.
5) Dense placement: the data is placed into the write buffer as dense as possible, to reduce blank regions or padded regions between pieces of data. In this way, buffer usage efficiency can be maximized and processing overheads due to data discontinuity can be reduced.
6) LBA storage: after 4 lines of the write buffer are full of the written data, LBA addresses are calculated based on the image coordinates recorded in the write ctrl, and the data of the 4 lines is written into the LBA.
7) It is determined that all work is completed based on the image coordinates. B tracking sequence numbers of lines and columns of the image recorded by the write ctrl, it is determined whether all the to-be-processed image data has been stored in the LBA. Specifically, in the case that the image coordinates cover a total number of lines and a total number of columns of the image, that is, data blocks of all lines and columns have been stored, all the work is completed. This step is also responsible for clearing the write buffer and updating the system state to prepare for a next round of work, thereby ensuring the integrity of data storage and the efficient use of system resources.

In the embodiment, the number of direct accesses to the LBA can be greatly reduced by preloading the image data into the buffer and completing necessary preprocessing in the buffer. This not only reduces the burden on the system bus, but also reduces the latency incurred by frequent accesses to the LBA. In the preprocessing stage, the pixel data is separated and recombined according to the storage characteristics and processing requirements of the LBA, so that the storage space of the LBA can be utilized maximally, the space waste is reduced, and the parallelism and efficiency of subsequent processing are improved.

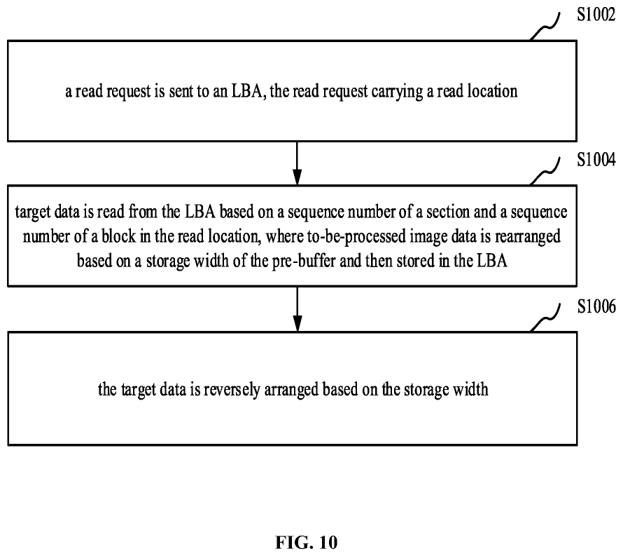

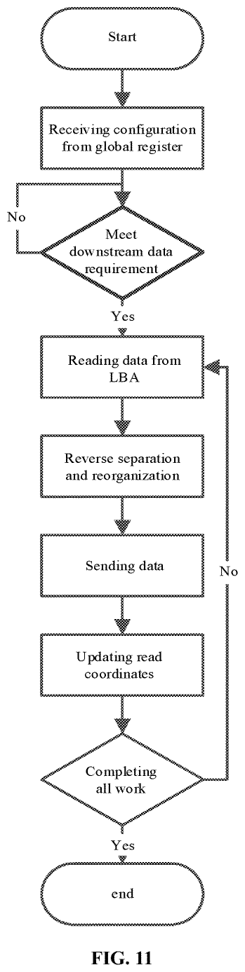

An image data reading method is provided according to an exemplary embodiment As shown in FIG. 10, the image data reading method includes the following steps 1002 to 1004.

In step 1002, a read request is sent to an LBA, the read request carrying a read location.

The read request is usually sent by a downstream module, and is configured to specify a data range that needs to be read. The read location includes logical positioning information of target data, the logical positioning information including a sequence number of a section and a sequence number of a block. The sequence number of the section is configured to identify a target section of the LBA, and the sequence number of the block is configured to position a specific data block in the section.

Upon reception of the read request, the pre-buffer sends the data read request to the LBA, and reads the target data from the LBA.

In step 1004, the target data is read from the LBA based on the sequence number of the section and the sequence number of the block included in the read location, where to-be-processed image data is rearranged based on a storage width of the pre-buffer and then stored in the LBA.

A memory section where the target data is located is determined by parsing the sequence number of the section included in the read position, and a storage address of the data within the target section is calculated based on the sequence number of the block. The target data is stored in the LBA after rearrangement based on the storage width of the pre-buffer, and reference may be made to the steps in the foregoing embodiments, which is not repeated in the embodiment.

In step 1006, the target data is reversely arranged based on the storage width.

Since the data stored in the LBA has been rearranged, the data needs to be reversely arranged during reading, to restore an original logic order of the data.

Optionally, one data block is read from the LBA each time. Since the to-be-processed image data is stored into the LBA as data blocks during data storage, one data block is read from the LBA each time. In addition, the data blocks are stored based on the storage width of the pre-buffer, so the original logic order can be obtained by performing reverse arrangement based on the storage width.

Moreover, if the data of the same channel has been merged during data storage, the channel data in the data block further needs to be separated in the reverse arrangement process after data reading. For the case of channel merging, the read data block may contain the data of multiple pixels on the same channel, and therefore needs to be remapped according to a channel arrangement rule of the image. For example, for the data in the YUV420 format, if the data of the luma channel Y has been merged during data storage, the data of channel Y needs to be restored to an original arrangement order pixel by pixel after data reading; and for the data of the chroma channels U and V, the data of different chroma channels may also be merged during data storage, so chrominance data needs to be redistributed to corresponding pixels according to the YUV420 format. In this way, the read data can be completely restored to the logical order before data storage, meeting requirements of subsequent processing.

In the embodiment, storage resources can be optimized during data storage by applying the dense arrangement manner; and since no blank data or alignment problem caused by storage fragments needs to be processed during data reading, the actual capacity of the memory can be efficiently used. In addition, this method of dense storage and reading can avoid redundant read operations and improve the utilization of the storage space.

Reference can be made to FIG. 11, which is a schematic diagram of steps of an image data reading method according to an exemplary embodiment.
1) Based on a configuration file from the global register, an image size, an output data format requirement, and an output data volume are analyzed.
2) It is determined, based on coordinate information in the write ctrl, whether a LBA data volume meets a design requirement of the downstream module.
3) When the data is sufficient, the read buffer sends a read request to the LBA based on image coordinates to read the data.
4) Data separation and reorganization are performed again based on the data format required by the downstream.
5) The data is sent to the downstream module and the image coordinates are updated until all work is completed.

It should be understood that although the steps in the flowcharts involved in the above embodiments are sequentially displayed as indicated by the arrows, these steps are not necessarily performed in the order indicated by the arrows. Unless explicitly stated herein, the execution of these steps is not strictly limited, and these steps may be executed in other orders. Moreover, at least part of the steps in the flowcharts involved in the above embodiments may include multiple sub-steps or multiple stages, these sub-steps or stages are not necessarily performed at the same time, but may be performed at different times; and the execution order of these sub-steps or stages is not necessarily performed sequentially, but may be performed in turn or alternately with at least part of other steps or the sub-steps or stages in other steps.

Based on the same inventive concept, image data writing and reading apparatuses further provided in embodiments of the present disclosure, for implementing the image data writing and reading methods mentioned above. The implementation solution for solving the problem provided by the apparatuses is similar to the implementation solution described in the above methods, so the specific limitations of one or more embodiments of the apparatuses for writing and reading image data provided below may refer to the limitations of the above methods for writing and reading image data, which are not repeated here.

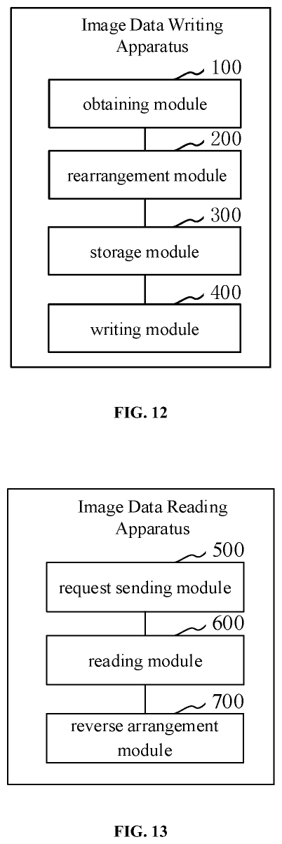

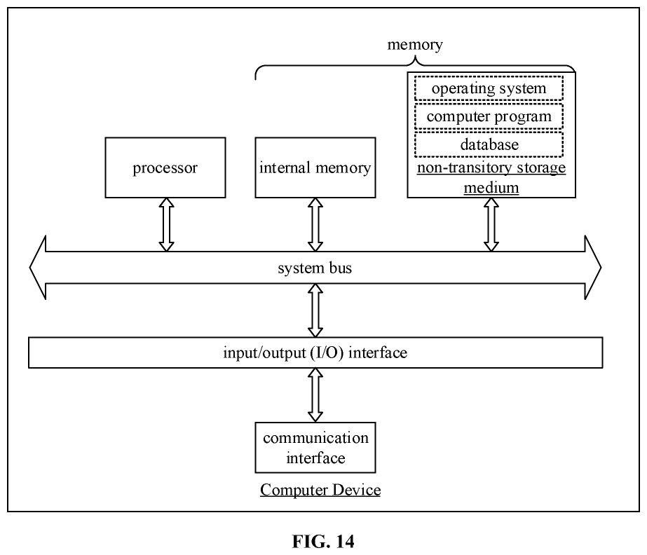

An image data writing apparatus is provided in an exemplary embodiment. As shown in FIG. 12, the image data writing apparatus includes: an obtaining module 100, a rearrangement module 200, a storage module 300, and a writing module 400.

The obtaining module 100 is configured to obtain to-be-processed image data.

The rearranging module 200 is configured to rearrange the to-be-processed image data based on a storage width of a pre-buffer to obtain arrangement information.

The storage module 300 is configured to store the to-be-processed image data into the pre-buffer based on the arrangement information.

The writing module 400 is configured to write the to-be-processed image data from the pre-buffer into an LBA when a preset number of lines of the pre-buffer have been filled with data.

In an embodiment, the apparatus further includes: a channel merging module, configured to perform channel merging in a case that the to-be-processed image data includes multiple channels.

In an embodiment, the channel merging module includes: a separation unit, configured to perform channel separation on each pixel in the to-be-processed image data to obtain channel streams corresponding to each pixel on respective channels; and a channel stream merging unit, configured to merge channel streams corresponding to respective pixels on a same channel.

In an embodiment, the rearranging module 200 includes: a line number calculation unit, configured to calculate a number of occupied lines of the to-be-processed image data in the pre-buffer abased on a channel bit width of the to-be-processed image data and the storage width; and an information calculation unit, configured to reorder the to-be-processed image data based on the number of occupied lines to obtain the arrangement information.

In an embodiment, the writing module 300 includes: a partitioning unit, configured to partition the LBA based on the to-be-processed image data to obtain multiple sections; and a data writing unit, configured to write the to-be-processed image data from the pre-buffer into respective sections.

In an embodiment, the partitioning unit includes: a line number calculation sub-unit, configured to calculate a number of lines per section based on a width of the to-be-processed image data, a pixel bit width, a number of memory sections in the LBA, and a width of the memory section; and a block calculation sub-unit, configured to partition the respective sections of the LBA according to the number of lines per section to obtain multiple blocks.

In an embodiment, the data writing unit includes: a section determining sub-unit, configured to determine a target section based on a line number of each data block and the number of lines per section; a line determining sub-unit, configured to determine a target line in the target section based on a column number of the each data block and the width of the memory section; and a writing sub-unit, configured to write the each data block into the target line.

In an embodiment, the LBA in the write module 300 further includes an arbitration unit. The arbitration unit arbitrates multiple received data write requests according to a preset arbitration manner, determines a target data write request, and writes to-be-processed image data corresponding to the target data write request into the LBA.

In an embodiment, the preset arbitration manner in the write module 300 includes one or any combination of round-robin arbitration, priority arbitration, and non-LRU arbitration. Round-robin arbitration is to sequentially arbitrate the data write requests according to a preset order. Priority arbitration is to arbitrate the data write requests according to preset priorities. Non-LRU arbitration is to arbitrate the data write requests according to a waiting time of each of the data write requests.

An image data reading apparatus is provided in an exemplary embodiment. As shown in FIG. 13, the image data reading apparatus includes a request sending module 500, a reading module 600, and a reverse arrangement module 700.

The request sending module is configured to send a read request to an LBA, where the read request carries a read location.

The reading module is configured to read target data from the LBA based on a sequence number of a section and a sequence number of a block included in the read location, where to-be-processed image data is rearranged based on a storage width of a pre-buffer and then stored in the LBA.

The reverse arrangement module is configured to perform reverse arrangement on the target data based on the storage width.

All or some of the modules in the image data writing and reading apparatuses may be implemented by software, hardware, or a combination thereof. The modules may be embedded in or independent of a processor in a computer device in a hardware form, or may be stored in a memory in the computer device in a software form, so that the processor invokes the modules to perform operations corresponding to the modules.

In an exemplary embodiment, a computer device is provided, which may be a server, and an internal structure diagram thereof may be as shown in FIG. 13. The computer device includes a processor, a memory, an input/output (I/O) interface, and a communication interface. The processor, the memory, and the I/O interface are connected via the system bus, and the communication interface is connected to the system bus via the I/O interface. The processor of the computer device is configured to provide computing and control capabilities. The memory of the computer device includes a non-transitory storage medium and an internal memory. The non-transitory storage medium stores an operating system, a computer program, and a database. The internal memory provides an environment for running of the operating system and the computer program in the non-transitory storage medium. The database of the computer device is configured to store to-be-processed image data. The I/O interface of the computer device is configured to exchange information between the processor and an external device. The communication interface of the computer device is configured to communicate with an external terminal through a network connection. The computer program, when executed by the processor, causes the processor to perform image data writing and reading methods.

A person skilled in the art may understand that the structure shown in FIG. 13 is merely a partial structure related to the solution of the present disclosure, and does not constitute a limitation on the computer device to which the solution of the present disclosure is applied. A specific computer device may include more or fewer components than those shown in FIG. 13, or combine some components, or have a different deployment of components.

In an exemplary embodiment, a computer device is provided, including a memory and a processor. The memory stores a computer program. When the processor executes the computer program, the steps of the method in any one of the foregoing embodiments are performed.

In an embodiment, a computer-readable storage medium is provided, where the computer-readable storage medium stores a computer program. When the computer program is executed by a processor, the steps of the method in any one of the foregoing embodiments are performed.

In an embodiment, a computer program product is provided, including a computer program. When the computer program is executed by a processor, the steps of the method in any one of the foregoing embodiments are performed.

A person of ordinary skill in the art may understand that all or some of the processes in the methods of the foregoing embodiments may be implemented by instructing related hardware by using a computer program, the computer program may be stored in a non-transitory computer-readable storage medium, and when the computer program is executed, the processes of the embodiments of the foregoing methods may be included. Any reference to a memory, a database, or another medium used in the embodiments provided in the present disclosure may include at least one of a non-transitory memory or a transitory memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, and the like. The transitory memory may include a random access memory (RAM), an external cache, or the like. By way of illustration and not limitation, the RAM may be in various forms, such as a static random access memory (SRAM) or a dynamic random access memory (DRAM). The database in the embodiments provided in the present disclosure may include at least one of a relational database or a non-relational database. The non-relational database may include, but is not limited to, a blockchain-based distributed database. The processor in the embodiments provided in the present disclosure may be a general-purpose processor, a central processing unit, a graphics processing unit, a digital signal processor, a programmable logic device, a data processing logic device based on quantum computing, an artificial intelligence (AI) processor, or the like, and is not limited thereto.

The technical features of the above embodiments may be arbitrarily combined, and in order to make the description concise, not all possible combinations of the technical features in the above embodiments are described, however, as long as there is no contradiction between the combinations of these technical features, it should be considered as the scope of the present disclosure.

The above embodiments only express several implementations of the present disclosure, and the description thereof is specific and detailed, but cannot be construed as limiting the scope of the present disclosure. It should be noted that for those of ordinary skill in the art, several variations and improvements can be made without departing from the concept of the present disclosure, which all fall within the protection scope of the present disclosure. Therefore, the protection scope of the present disclosure shall be subject to the appended claims.

What is claimed is:

1. An image data writing method, comprising:
obtaining to-be-processed image data;
rearranging the to-be-processed image data based on a storage width of a pre-buffer to obtain arrangement information;
storing the to-be-processed image data into the pre-buffer based on the arrangement information; and
writing the to-be-processed image data from the pre-buffer into a line buffer array (LBA) when a preset number of lines of the pre-buffer are filled with data.

2. The image data writing method according to claim 1, after obtaining the to-be-processed image data, further comprising:
performing channel merging in a case that the to-be-processed image data comprises a plurality of channels.

3. The image data writing method according to claim 2, wherein performing channel merging comprises:
performing channel separation on each pixel in the to-be-processed image data to obtain channel streams corresponding to each pixel on respective channels; and
merging channel streams corresponding to respective pixels on a same channel.

4. The image data writing method according to claim 1, wherein rearranging the to-be-processed image data based on the storage width of the pre-buffer to obtain the arrangement information comprises:
calculating a number of occupied lines of the to-be-processed image data in the pre-buffer based on a channel bit width of the to-be-processed image data and the storage width; and
reordering the to-be-processed image data based on the number of occupied lines to obtain the arrangement information.

5. The image data writing method according to claim 1, wherein writing the to-be-processed image data from the pre-buffer into the LBA comprises:
partitioning the LBA based on the to-be-processed image data to obtain a plurality of sections; and
writing the to-be-processed image data from the pre-buffer into respective sections.

6. The image data writing method according to claim 5, wherein after partitioning the LBA based on the to-be-processed image data to obtain the plurality of sections, further comprising:
calculating a number of lines per section based on a width of the to-be-processed image data, a pixel bit width, a number of memory sections in the LBA, and a width of the memory section; and
partitioning the respective sections of the LBA according to the number of lines per section to obtain a plurality of blocks.

7. The image data writing method according to claim 6, wherein each section has a plurality of lines, and the to-be-processed image data is stored in the pre-buffer as data blocks; and
wherein writing the to-be-processed image data into respective sections comprises:
determining a target section based on a line number of each data block and the number of lines per section;
determining a target line in the target section based on a column number of the each data block and the width of the memory section; and
writing the each data block into the target line.

8. The image data writing method according to claim 1, wherein the LBA further comprises an arbitration unit, and the arbitration unit arbitrates a plurality of received data write requests according to a preset arbitration manner, determines a target data write request, and writes the to-be-processed image data corresponding to the target data write request into the LBA.

9. The image data writing method according to claim 8, wherein the preset arbitration manner comprises one or any combination of a round-robin arbitration, a priority arbitration, and a non-least recently used arbitration;
wherein the round-robin arbitration is to sequentially arbitrate the data write requests according to a preset order;
the priority arbitration is to arbitrate the data write requests according to preset priorities; and
the non-least recently used arbitration is to arbitrate the data write requests according to a waiting time of each of the data write requests.

10. An image data reading method, comprising:
sending a read request to a line buffer array (LBA), the read request carrying a read location;
reading target data from the LBA based on a sequence number of a section and a sequence number of a block comprised in the reading location, wherein to-be-processed image data is rearranged based on a storage width of a pre-buffer and then stored in the LBA; and
reversely arranging the target data based on the storage width.

11. An image data writing apparatus, comprising:
an obtaining module, configured to obtain to-be-processed image data;
a rearranging module, configured to rearrange the to-be-processed image data based on a storage width of a pre-buffer to obtain arrangement information;
a storage module, configured to store the to-be-processed image data into the pre-buffer based on the arrangement information; and
a writing module, configured to write the to-be-processed image data from the pre-buffer into a line buffer array when a preset number of lines of the pre-buffer are filled with data.

12. A computer device, comprising a memory and a processor, wherein the memory stores a computer program, and the processor, when executing the computer program, performs steps of the image data writing method according to claim 1.

13. A non-transitory computer-readable storage medium, which stores a computer program, wherein the computer program, when executed by a processor, causes the processor to perform steps of the image data writing method according to claim 1.

14. A computer program product, comprising a computer program, wherein the computer program, when executed by a processor, causes the processor to perform steps of the image data writing method according to claim 1.

15. A computer device, comprising a memory and a processor, wherein the memory stores a computer program, and the processor, when executing the computer program, performs steps of the image data reading method according to claim 10.

16. A non-transitory computer-readable storage medium, which stores a computer program, wherein the computer program, when executed by a processor, causes the processor to perform steps of the image data reading method according to claim 10.

17. A computer program product, comprising a computer program, wherein the computer program, when executed by a processor, causes the processor to perform steps of the image data reading method according to claim 10.
